(19) United States
(12) Patent Application Publication
(10) Pub. No.: US 2009/0063290 A1
(43) Pub. Date: Mar. 5, 2009

(54) System and Method Utilizing A Customer Relationship Management Software Application To Convert A Price Quote Into An Electronic Shopping Cart

(75) Inventors: John Mehew, Biscayne Park, FL (US); Jeff Buck, Dusseldorf (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Qiagen, GmbH, Hilden (DE)

(21) Appl. No.: 11/849,555

(22) Filed: Sep. 4, 2007

(51) Int. Cl. G06Q 40/00

(52) U.S. Cl. 705/26; 705/28

(57) ABSTRACT

A customer requests a price quote for certain goods or services. The requisite information is entered into a customer relationship management (CRM) software application, which is capable of sending a price quote to the customer. The CRM application is provisioned with a feature that creates an e-mail containing a weblink to an electronic shopping basket, along with other information pertaining to the price quote. Once finalized, the e-mail is sent to the customer who had requested the price quote. If the customer then activates the weblink, the web site application displays the electronic shopping cart to the customer, and gives the customer the opportunity to conclude the sale. This makes it easy for the customer to purchase the goods or services in the shopping cart, without further the delay. For the vendor, it increases the likelihood of converting a price quote into a sale.

### BACKGROUND OF THE INVENTION

1. Field of the Invention

The present invention is related to a method for pre-filling an electronic shopping cart for a customer. More particularly, it is directed to e-mailing a deep link to the shopping cart to a customer who has previously expressed an interest in the contents of the shopping cart.

2. Background

In many commercial organizations, sales are made pursuant to direct contact between a salesperson and a customer either by phone or in person. During a sales contact, the customer may express an interest in purchasing particular goods and services, and even request a quote. To keep track of customers, sales leads, sales contacts, orders and the like, a customer relationship management (CRM) application may be employed by the salesperson.

FIG. 1 shows an exemplary quote sheet 100 from a typical CRM application configured to assist a salesperson in preparing a quote. The quote sheet 100 includes a first area comprising quote identifying information, shown generally as 110. The quote identifying information may include information about the quote name 112, the agreement number 114, the customer name 116, and the contact name 118 at the customer. A comment field 120 may be provided to memorialize particulars about the customer, associated sales contact or other information for which no pre-defined field has been provided.

The quote sheet 100 also includes a second area 130 for displaying and/or entering retrieving various categories of information germane to the quote, each selected by a tab 132, such as a quote details tabs 132A, sales team category tab 132B, notes tab 132C, shipping information tab 132D, logging information tab 132E, back-end system (SAP, in this case) tab 132F, and so forth.

The quote sheet 100 also includes a third area 140 for displaying and/or entering specific information about the products or services for which a quote was requested. In FIG. 1, the third area 140 includes two line items 140A, 140B, each corresponding to a specific product or service for which a quote was requested. The columns for each line item include such things as the product description 142, catalog number/SKU144, the quantity 146, the list price 148, the quoted price 150, the discount granted 152, the extended price 154, among other things.

The quote sheet 100 also includes a fourth area 170 comprising a number of buttons for printing, saving and saving the quote, among other actions.

### SUMMARY OF THE INVENTION

In one aspect, the invention is directed to a vendor computer system configured to provide a customer with a price quote for goods or services in which the customer has expressed an interest in purchasing. The inventive vendor computer system includes a customer relationship management application configured to generate a price quote for designated goods or services in which a customer has expressed interest in purchasing; and initiate the creation of an electronic shopping cart containing the designated goods or services, and a weblink to the electronic shopping cart. The system also includes an e-mail application invoked from the customer relationship management application and configured to send the weblink to the customer. Lastly, the system includes a vendor website application configured to receive the weblink from a requesting computer; retrieve the electronic shopping cart in response to receiving the weblink; and provide the electronic shopping cart to the requesting computer.

In another aspect, the present invention is directed to a method for a vendor who has been asked by a customer to quote a price for certain goods or service, to send the price quote in a manner that may increase odds of completing the sale. The vendor uses a CRM application having an e-mail option to provide the price quote to the customer. However, when the price quote is generated and the e-mail option is invoked, the web site creates a pre-filled electronic shopping cart with all the items in the quote. The method is such that when a customer receives a quote by e-mail, the customer can click on a link that will take them to the pre-filled electronic shopping cart at a web site associated with the vendor. There, the customer can simply review the shopping cart and if he or she so desires, complete the purchase.

### BRIEF DESCRIPTION OF THE DRAWINGS

FIG. 1 shows an exemplary quote sheet from a prior art CRM application.

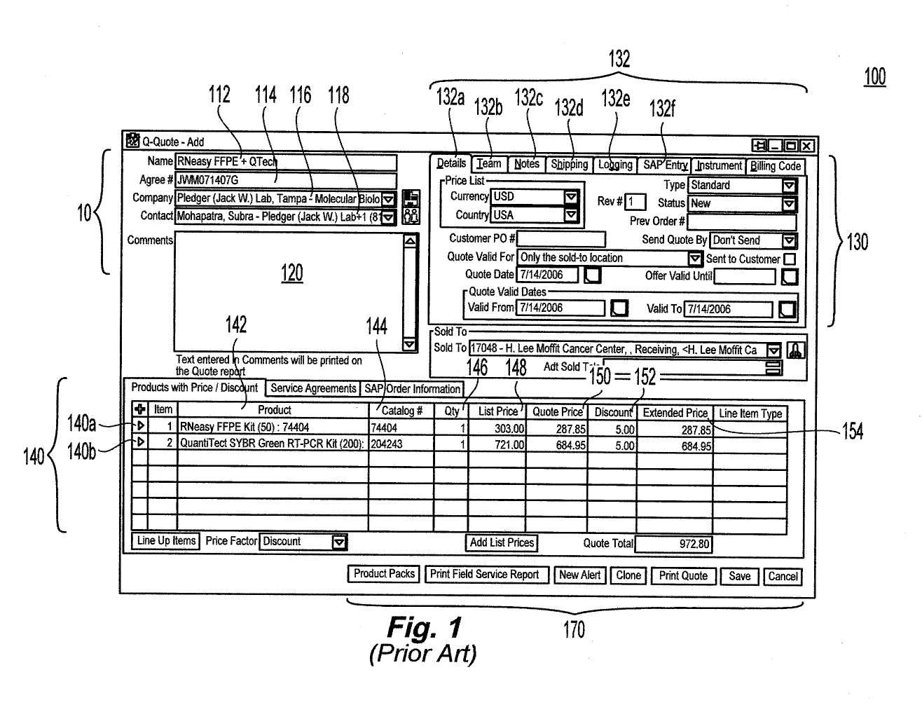

FIG. 2 shows an exemplary quote sheet from a CRM application in accordance with the present invention.

FIG. 3 shows an exemplary e-mail application window launched using the ‘create shopping cart’ button in FIG. 2.

FIG. 4 shows an exemplary web page displayed to the customer, upon activating a weblink in the received e-mail.

FIG. 5 shows a flow chart detailing steps carried out by a salesperson to create and send a quote to a customer.

FIG. 6 shows message flow among various software applications and platforms involved in implementing the present invention.

### DETAILED DESCRIPTION OF THE INVENTION

In one aspect, the present invention permits a salesperson to send an e-mail to a customer, thereby providing the customer with a link which, when activated, presents the customer with a shopping cart corresponding to the items that are the subject of a price quote.

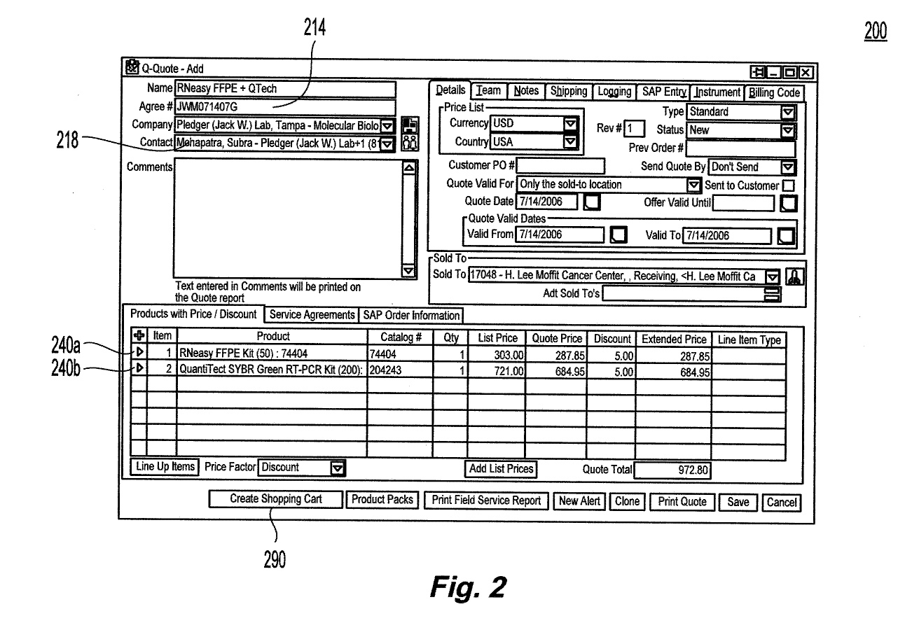

FIG. 2 shows one embodiment of a quote sheet 200 from an CRM application in accordance with the present invention. An exemplary CRM application may be of the sort available from Pivotal (www.pivotal.com) for customer relationship management. The quote sheet 200 is similar most respects to the prior art quote sheet 100, and includes such items of information as the quote tracking number 214, the contact's name 218, and the line items 240A, 240B, each corresponding to a specific product or service for which a quote was requested. One significant difference, however, is that quote sheet 200 includes a button 290 which, when activated, launches an e-mail client. In one embodiment, activating button 290 initiates the creation of an electronic shopping cart containing the goods or services that are the subject of a price quote, and also the formation of a weblink to the electronic shopping cart.

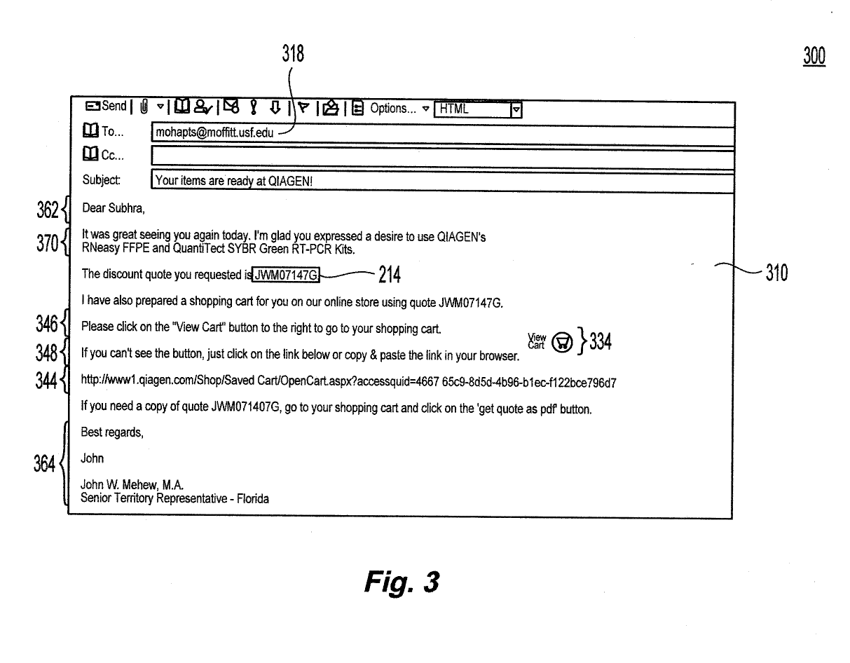

FIG. 3 shows one embodiment of an e-mail window 300 of an e-mail client application that may be launched from activating the button 290 from the quote sheet 200. When the e-mail client is launched, a number of items are populated. For instance, the ‘To’ field is pre-filled with the e-mail address 318 of the contact 218 from the quote sheet 200. In addition, a draft message 310 is also automatically pre-filled with a number of items. One such item is the quote tracking number 214. Another item is at least one weblink which, when invoked, presents the customer/recipient with an electronic shopping cart. The weblink to the electronic shopping cart may be in the form of clickable icon 334 shaped as a shopping cart or a weblink 344 constituting an uniform resource locator (URL). Yet another item is one or more instructions 346, 328 explaining that one may either click on the icon 334, clink on the weblink 344, or cut and paste the URL to view the contents of the shopping cart comprising the item for which a quote was requested. Other items, such as a greeting 362 to the e-mail addressee and a signature block 364 may also be pre-filled.

After the e-mail window 300 has been launched and the various items pre-filled, the user/sender may then create (or modify, if a draft is provided) a personalized message 370, perhaps reminding the customer/recipient of their prior contact and subjects discussed during their prior contact. The user/sender may also modify any of the pre-filled items as well, and/or utilize any of the other features provided by the e-mail client, before sending the message. Thus, the e-mail application is invoked from the customer relationship management application, is configured to send a weblink to said customer, along with a personalized message and other information.

At some later time, the customer/recipient receives the e-mailed message via his or her own e-mail client. Upon opening the e-mail, the customer/recipient reads the message. If the customer/recipient so inclined, he or she may invoke that weblink by: (a) clicking on the icon 324, (b) clicking on the link 344, or (c) cutting and pasting the URL corresponding to the weblink into their browser. If customer/recipient performs any of these actions, an http call is made to the vendor's web site. The vendor's web site then retrieves a record associated with the quote tracking number 214, and provides it to the customer/recipient's browser.

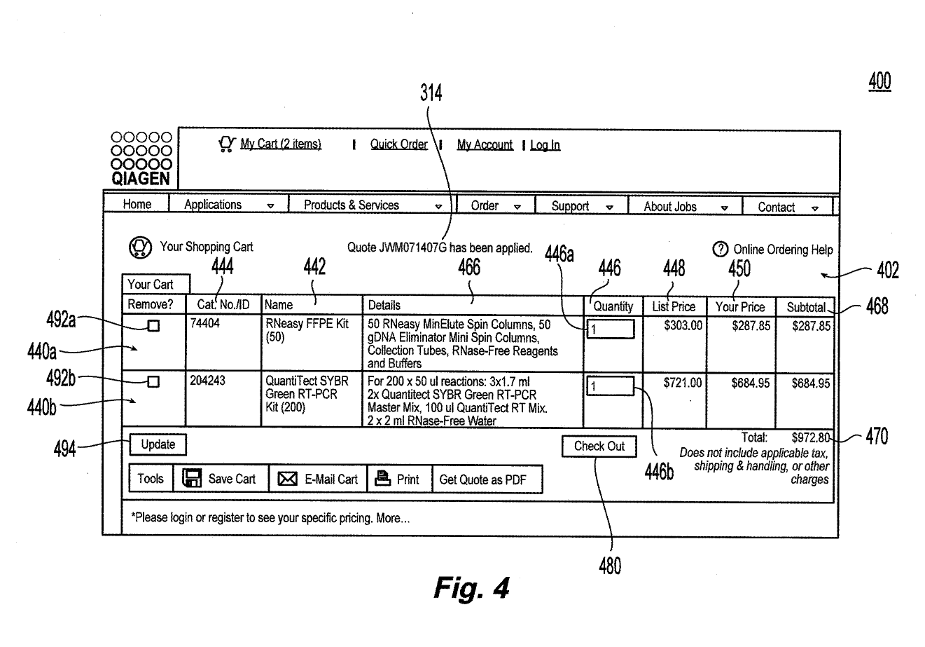

FIG. 4 presents one embodiment of the web page 400 that the customer/recipient's browser might display, if any of the three aforementioned actions are taken. The web page 400 displays an electronic shopping cart 402 comprising a number of items. Included among these items are the quote identifier 214, and line items 440A, 440B, each corresponding to one of the line items 240A, 240B from the quote sheet 200 (see FIG. 2). The columns for each line item 440A, 440B again include such things as the catalog number/SKU 444, product name 442, quantity 446, list price 448, and the quoted price (“your price”). In addition to these, each line item may also include the product's detailed description 466 and a subtotal 468, among other things. A total price 480 for the items subject to the quote may also be provided.

If the customer/recipient is satisfied with the selections as initially displayed, the customer may simply click on the check out button 480 to complete the transaction.

If, on the other hand, the customer/recipient would like to modify the order, he or she may do so. In particular, the customer/recipient may edit the quoted items by either checking remove boxes 492A, 492B, or adjusting the value in the quantity windows 446A, 446B. Once satisfied, the customer/recipient may then click on the checkout button 480 to complete the transaction.

The checkout window (not shown) will be pre-filled with information taken from the CRM application or the customers already stored information on the website, such as shipping information, billing information and the like. Provisions may be made for the customer/recipient to pay by credit card, or have the costs billed to some other account.

It can thus be seen from the foregoing, that the present invention contemplates allowing a salesperson to convert a price quote into an electronic shopping cart to facilitate a customer purchase.

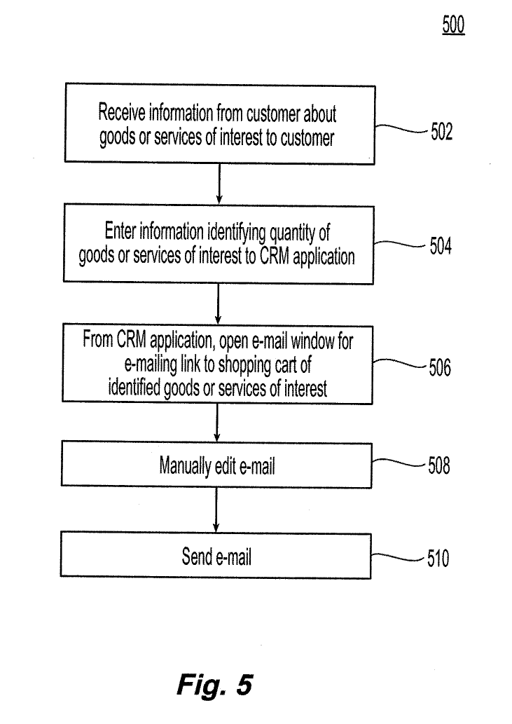

FIG. 5 shows a flowchart 500 summarizing the steps carried out by a salesperson using a CRM application in accordance with the present invention. In step 502, the salesperson receives information from the customer about goods or services of interest to customer. In step 504, the information identifying quantity of goods or services of interest is entered into a CRM application. In step 506, the salesperson/sender, from within the CRM application, invokes an e-mail client or website that sends e-mail, to thereby open an e-mail window pre-filled with one or more weblinks to an electronic shopping cart of those identified goods or services of interest. In step 508, the salesperson/sender may optionally edit the e-mail, and in step 510, sends the e-mail to the customer/recipient.

Thus, from the CRM application, the salesperson creates both a quote and a pre-filled shopping cart for the client, after which a link is emailed to the client from the e-mail client invoked by the CRM application. When the client clicks on the link in the email, they are taken to their pre-filled shopping cart with all the items from the quote. In one sense, then, the sales representative has shopped for the customer, filled the shopping cart with those items that the customer is predisposed to purchase, and walked the customer to the check out register.

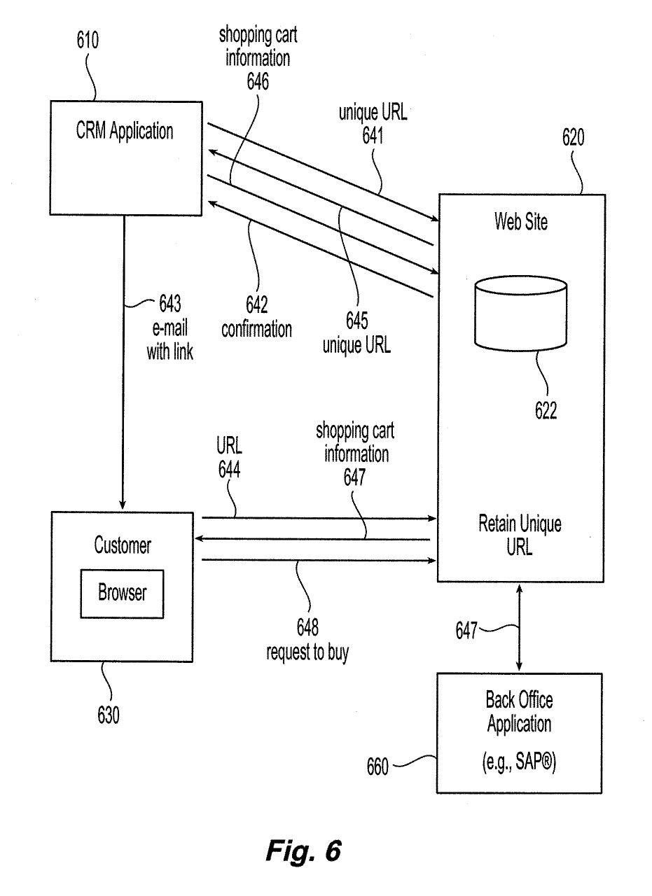

FIG. 6 illustrates a system 600 in accordance with the present invention, showing the interaction between various software applications. When the sales representative creates a new quote and clicks, the ‘Create Shopping Cart’ button 290 on the screen of the CRM application 610, a number of things are initiated.

First, the CRM application creates a unique URL that points to a set of quote data corresponding to the quote tracking number 214. It then sends a first message 641 comprising this unique URL to the vendor's web site application 620, via middleware. The vendor's web site application 620, which is normally used by customers to place orders for good or services, retains this unique URL for future reference, in the event that a customer requests data referenced by the unique URL. The vendor's web site application 620 may send a second message 642 back to the CRM application confirming receipt. Alternately, the vendor's website may connect in real-time and retrieve data related to the quote from the CRM system, when the user uses the link he or she has received. The CRM application 610 also invokes the e-mail client (e.g., Microsoft Outlook) or a webpage that sends e-mail, or a form within the CRM application that sends e-mail, and populates the draft e-mail window or web fields with one or more weblinks 334, 344 comprising the unique URL, instructions and the like, as discussed above. The salesperson/sender finalizes and sends a third message 643 comprising the e-mail to the computer 630 of the customer/recipient.

Upon opening the e-mail, if the customer chooses to activate one of the weblinks 334, 344 (or cuts and pastes the unique URL into his or browser), the customer's browser is invoked and a fourth message 644 comprising the unique URL is sent to web site application 620.

In response to the fourth message 644, the web site application 620 receives the unique URL sent by the customer's requesting computer 630 and matches the newly received unique URL with the one that was previously stored. The web site application 620 then sends a fifth message 645 comprising the unique URL to the CRM application 610, requesting the corresponding information.

In response to the fifth message 645, the CRM application 610 sends the web site application 620 a sixth message 646 comprising the shopping cart information.

The web site application 620 then sends a seventh message 647 comprising this shopping cart information to the customer's requesting computer 630 for display in the browser.

It can thus be seen that the website application is configured to receive the unique URL from a requesting computer, retrieve the electronic shopping cart in response to receiving the unique URL, and provide the electronic shopping cart back to the requesting computer 630.

If the customer wishes to purchase the items in the electronic shopping cart, an eighth message 648 is sent from the requesting computer 630 back to the web site application 620 signifying the customer's intent, and the web site application allows the customer to continue with the transaction.

Finally, as the transaction is being conducted, the web site application 620 may exchange messages 647 with one or more back office applications 660 to check inventory and record the sale. Typically, however, such back office applications also can track inventory, track orders, generate invoices, create sales reports, and handle other tasks. An exemplary back office application with such capabilities may be of the sort available from SAPS (www.sap.com).

To implement the present invention, a number of modifications may be needed to provide the CRM application 610, the e-mail software, the web site application 620 and the back office application 660 with certain functionalities. Among these may be the following:

(1) Change the quote form in CRM application 610 to only allow input of structured data, and provision it to have a ‘Create Shopping Cart’ button 290;

(2) Add functionality to the CRM application 610 to generate a unique URL referring to a set of quote data;

(3) Add functionality to the CRM application 610 to create an e-mail containing the unique URL and send it to one or more customer's e-mail address;

(4) Change data synchronization between the CRM application 610 and the back office application 660 to ensure CRM accounts have correct back office application 660 partner role;

(5) Add functionality to the CRM application 610 to transmit quote data to a middleware system or directly to the vendor's website;

(6) If necessary, enable the middleware system to insert CRM-generated quote data into the web site application 620 and the back office application 660;

(7) Enable the web site application 620 to fetch and display CRM-quote data in a shopping cart format when the unique URL is called; and

(8) Enable the web application to transfer appropriate reference IDs to the back office application 660 when the electronic shopping cart is ordered.

People skilled in the art of configuring and modifying such applications can make the necessary modifications using toolkits, programming and other software tools.

The method in accordance with the present invention potentially provides a number of advantages. First, it may increase revenue by driving more sales to completion. Second, by presenting the customer with a shopping cart in an e-mail, it lowers sales barriers and addresses the issue of customer inertia. Third, it increases traffic to the vendor's web site via the shopping cart link, whether or not the customer completes the sale. Once at the web site, customers may browse and shop for items beyond those in the shopping cart. Fourth, time and cost savings may be realized since it is anticipated that sales persons will have to make fewer follow-up contacts concerning the shopping cart items. Finally, fewer errors may be made in the ordering process, since the customer may edit the contents of the shopping cart, and there is no transcription of the customer order by a sales representative. Additionally, people who receive the shopping cart link could pass it on to other people to actually place the order.

While the present invention has been described herein above in connection with a plurality of aspects and embodiments, it is understood that these aspects and embodiments were presented by way of example with no intention of limiting the invention. Accordingly, the present invention should not be limited to any specific embodiment or aspect, but rather construed in breadth and broad scope in accordance with the recitation of the claims appended hereto.

What is claimed is:

1. A vendor computer system configured to provide a customer with a price quote for goods or services in which the customer has expressed an interest in purchasing, the vendor computer system comprising:
(a) a customer relationship management application configured to:
generate a price quote for designated goods or services in which a customer has expressed interest in purchasing; and
initiate the creation of an electronic shopping cart containing the designated goods or services, and a weblink to the electronic shopping cart;
(b) an e-mail application invoked from said customer relationship management application and configured to send said weblink to said customer; and
(c) a website application configured to:
receive said weblink from a requesting computer;
retrieve said electronic shopping cart in response to receiving said weblink; and
provide said electronic shopping cart to the requesting computer.

2. The vendor computer system according to claim 1, further comprising:
(c) a back office application in communication with said website application, said back office application configured to keep track of inventory in response to said purchase request.

3. A method for a vendor to facilitate a customer's purchase of goods or services in which the customer has expressed an interest, the method comprising:
(a) the vendor receiving information that identifies goods or services in which a customer has expressed interest in purchasing;
(b) from a customer relationship management (CRM) application in which said customer's contact information is already present:
(b1) the vendor generating a price quote for the designated goods or services; and
(b2) the vendor activating a function to create an electronic shopping cart containing the designated goods or services, and storing the shopping cart; and
(c) the vendor sending an e-mail to the customer, the e-mail comprising a weblink leading to said electronic shopping cart whose contents may then be purchased by the customer.

4. The method according to claim 3, further comprising:
automatically creating a draft e-mail from said software application, the draft e-mail including said weblink; and
manually revising the draft e-mail, before the e-mail is sent to the customer.

5. The method according to claim 3, further comprising:
(d) receiving, at a website of the vendor, said weblink from a requester;
(e) retrieving said electronic shopping cart in response to receiving said weblink; and
(f) providing said electronic shopping cart to the requester.

6. The method according to claim 5, further comprising:
generating, by said CRM application, a unique uniform resource locator (URL) corresponding to said weblink.

7. The method according to claim 6, further comprising:
sending said unique URL to said website of the vendor.
